(19) United States
(12) Patent Application Publication
(10) Pub. No.: US 2015/0295722 A1
(43) Pub. Date: Oct. 15, 2015

(54) KEY GENERATION APPARATUS AND METHOD FOR GENERATING A KEY

(71) Applicants: Rainer Falk, Poing (DE); Kai Fischer, Baldham (DE); Anne Passarelli, Munchen (DE)

(72) Inventors: Rainer Falk, Poing (DE); Kai Fischer, Baldham (DE); Anne Passarelli, Munchen (DE)

(21) Appl. No.: 14/682,739

(22) Filed: Apr. 9, 2015

(30) Foreign Application Priority Data
Apr. 10, 2014 (DE) 102014206943.2

(51) Int. Cl. H04L 9/32; H04L 9/08

(52) U.S. Cl. CPC H04L 9/3278; H04L 9/0822

(57) ABSTRACT

A key generation apparatus for generating a key using a physical unclonable function includes a memory device configured to store a plurality of auxiliary data records, each auxiliary data record of the plurality of auxiliary data records having auxiliary data and supplementary information items, a selection device configured to select an auxiliary data record based on the supplementary information items, and a generation device configured to generate the key based on the auxiliary data of the selected auxiliary data record and using the physical unclonable function.

This application claims the benefit of DE 102014206943.2, filed on Apr. 10, 2014, which is hereby incorporated by reference in its entirety.

### FIELD

The disclosed embodiments relate to generating a key using a physical unclonable function (PUF).

### BACKGROUND

Many applications call for a cryptographic key. The cryptographic key may be generated by a key extractor, such as a fuzzy key extractor, using a physical unclonable function (PUF), for example.

Physical unclonable functions on a semiconductor circuit are known. There are various types of PUFs in existence, as may be taken from the publication available at https://www.cosic.esat.kuleuven.be/ecrypt/courses/albena11/slides/ingrid_verbauwhede_p ufs.pdf, for example. These include SRAM-PUFs, ring oscillator PUFs and arbiter PUFs, for example. The latter, inter alia, provide a response value based on a challenge value.

A fuzzy key extractor, as cited above, involves auxiliary data, also called helper data, which is produced when a key is generated. The auxiliary data additionally needs to be stored, which calls for a nonvolatile memory. An overview of PUF-based key generation is provided at http://www.cosic.esat.kuleuven.be/publications/article-2323.pdf (M. Yu, D. M'Raïhi, S. Devadas, and I. Verbauwhede, “Security and Reliability Properties of Syndrome Coding Techniques Used in PUF Key Generation” in GOMACTech conference 38, GomacTech, pages 1-4, 2013) and at http://www.nxp.com/documents/other/75017366.pdf (NXP: PUF—Physical Unclonable Functions, Protecting next-generation Smart Card ICs with SRAM-based PUFs), for example.

The PUF properties are dependent on the supply voltage and the ambient temperature, inter alia, or on other ambient conditions too. For this reason, inter alia, error correction is warranted in order to ascertain a stable value from noisy, slightly different PUF responses, e.g., in the case of a challenge/response method.

One approach involves allowing a large number of bit errors when selecting the error correction method of the PUF key extractor. However, this approach leads to a complex error correction method. The approach additionally has limits for PUFs that have a distinctly fluctuating response over a wide range of fluctuation (e.g., temperatures from 40° C. to 90° C.), that is to say not just a limited number of bit errors.

WO 2013/083415 A2 discloses a PUF key extractor that ascertains a reliability information item during the error correction.

U.S. Pat. No. 8,312,289 B2 discloses the practice of updating or re-determining the auxiliary data in the course of operation while errors are increasing.

The publication available at http://rijndael.ece.vt.edu/puf/paper/fpl2009.pdf (Abhranil Maiti, Patrick Schaumont: IMPROVING THE QUALITY OF A PHYSICAL UNCLONABLE FUNCTION USING CONFIGURABLE RING OSCILLATORS, pages 703-707, 19th International Conference on Field Programmable Logic and Applications, FPL 2009, Aug. 31-Sep. 2, 2009, Prague, Czech Republic) discloses the practice of implementing a PUF so robustly that key extraction involves correcting only a small number of bit errors.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, the disclosed embodiments may provide a reliable key using a physical unclonable function under various conditions.

A key generation apparatus for generating a key using a physical unclonable function (PUF) is described. The key generation apparatus has a memory device for storing a plurality of auxiliary data records, where each of the auxiliary data records has auxiliary data and supplementary information items, a selection device for selecting an auxiliary data record based on the supplementary information items, and a generation device for generating the key based on the auxiliary data of the selected auxiliary data record and using the PUF.

The respective device, for example a selection device or generation device, may be implemented in hardware and/or also in software. In the case of a hardware implementation, the respective device may be in the form of (e.g., configured as) an apparatus or in the form of part of an apparatus, for example in the form of a computer or in the form of a microprocessor. In the case of a software implementation, the respective device may be in the form of a computer program product, in the form of a function, in the form of a routine, in the form of part of program code or in the form of an executable object.

In accordance with the key generation device, the memory device stores a plurality of sets of auxiliary data or helper data for the generation device. The generation device may be a PUF key extractor that uses the PUF and the auxiliary data to generate a cryptographic key.

Based on the supplementary information items, an auxiliary data record, and hence the auxiliary data contained therein, may be selected by the selection device. The type of selection of an auxiliary data record may be dependent on the type of supplementary information item. By way of example, the selection device may ascertain whether a particular criterion needs to be met and which supplementary information items meet this criterion, or whether the supplementary information items contain a particular value.

Generation and storage of a plurality of sets of auxiliary data may be effected during manufacture, for example. If the supplementary information items are ambient conditions, ambient conditions may be simulated in an apparatus. By way of example, an appliance that includes the PUF may be exposed to different temperatures in a temperature chamber. In this case, a plurality of temperature-specific auxiliary data records may be created.

The proposed key generation apparatus may be used to ensure, e.g., for a large range of ambient conditions, that PUF-based key extraction or generation may reliably generate a particular cryptographic key. This is the case because the supplementary information items may be taken as a basis for selecting different auxiliary data. In this way, the key may be generated taking account of various criteria, such as the ambient conditions, inter alia, which criteria have an influence as a result of the selection of one of the auxiliary data records based on the supplementary information items.

According to one embodiment, the key generation device has an ascertainment device for ascertaining at least one present value for at least one ambient condition of the PUF, where the memory device is configured to store, for each auxiliary data record, at least one reference value for the at least one ambient condition as supplementary information items, and where the selection device is configured to select the auxiliary data record based on the at least one present value and the at least one reference value.

Because the properties of the PUF likewise change with changing ambient conditions, the supplementary information items may relate particularly to ambient conditions. Present values of an ambient condition may be ascertained by the ascertainment device and made available to the selection device. The selection device may then decide which of the stored supplementary information items, which each contain at least one reference value, correspond to the currently determined value and may take this as a basis for selecting the auxiliary data or the auxiliary data record that is intended to be used for generating the key.

Thus, this means that the key extraction involves taking ambient conditions, e.g., taking the ambient temperature, as a basis for selecting auxiliary data. This selection may be made explicitly using an appropriate ascertainment device. That is to say that the currently measured temperature, for example, is taken as a basis for selecting an auxiliary data record that is associated with the temperature.

According to a further embodiment, the memory device is configured to store, for each auxiliary data record, a reference value range for the at least one ambient condition as a supplementary information item.

According to this embodiment, each auxiliary data record may have a reference value range. This means that the auxiliary data of an auxiliary data record are suitable not just for a single present value but rather for a plurality of present values of the ambient condition.

According to a further embodiment, the selection device is configured to select an auxiliary data record whose reference value range corresponds to the at least one present value.

The reference value range may contain precisely the at least one present value. If none of the reference value ranges contains the present value, the auxiliary data record whose reference value range is closest to the present value may be selected.

According to a further embodiment, the selection device is configured so that if the stored reference value ranges of the plurality of auxiliary data records overlap then it selects that auxiliary data record whose reference value range has the at least one present value as a mean value.

In the event of an overlap between the stored reference value ranges, the selection device may ascertain the reference value range for which the present value is best situated in the center, that is to say represents the median, or which reference value range has the present value as an average value.

According to a further embodiment, the selection device is configured to output an error signal if none of the supplementary information items has the at least one present value.

If the selection device cannot find the present value in any of the stored auxiliary data records, the selection device may output an error signal instead of selecting one of the auxiliary data records. In response to the error signal, new auxiliary data may be produced and may be stored as a new auxiliary data record with the present value as a state information item, for example. This may be effected when the key may be reconstructed again, i.e., the ambient conditions allow the selection of auxiliary data records. Alternatively, the selection device may try out all of the already existent auxiliary data records and select an auxiliary data record that has the best fit. This may be determined based on errors that occur.

Following generation of the key, that is to say when the key is available, a change in the ambient conditions to a value range for which there is still no auxiliary data record available may prompt a new auxiliary data record to be generated for the present value of the ambient condition and to be stored with a supplementary information item that is dependent thereon.

According to a further embodiment, the ascertainment device has a sensor for capturing the at least one present value for at least one ambient condition of the PUF.

The sensor may be any type of sensor that is suitable for capturing the relevant ambient condition. A plurality of sensors may also be provided. In this case, a plurality of ambient conditions may also have an influence on the supplementary information items or the selection of the auxiliary data records.

According to a further embodiment, the at least one ambient condition is an ambient temperature, humidity, air pressure, vibration, acceleration and/or supply voltage for the PUF.

The PUF may be influenced by various ambient conditions. Each of these ambient conditions may be used as a supplementary information item when selecting an auxiliary data record. Depending on the type of ascertainment device used, the stored supplementary information items may be adapted in respect of their type.

A plurality of ambient conditions may be used as a supplementary information item. In this case, the various ambient conditions may be prioritized. By way of example, temperature may be prioritized ahead of humidity. Alternatively, a value of the temperature may be determined, and this determination may be taken as a basis, for example if the temperature is lower than a predetermined value, for determining humidity to be unsuitable and using another ambient condition as a second value.

According to a further embodiment, the generation device is configured to generate a new auxiliary data record for the plurality of auxiliary data records and to transfer the new auxiliary data record to the memory device for storage.

In this way, auxiliary data, for example for as yet uncovered ranges of ambient conditions, may be ascertained and stored in the course of operation. This may be realized, e.g., in the case of temperature fluctuations, because these may occur constantly and thus the auxiliary data records for temperatures may be added at the top or at the bottom. Therefore, if the key may be extracted or generated when a temperature range for which auxiliary data are available is present, a change in the temperature to an uncovered range may prompt the creation of a new set of auxiliary data for this temperature range.

According to a further embodiment, the memory device is configured to store, for each auxiliary data record, a quality criterion as a supplementary information item. In this case, the selection device is configured to select the auxiliary data record based on the quality criterion.

As an alternative to the explicit selection based on ambient conditions, the selection may be made implicitly. Because an information item about the bit errors corrected during key extraction or a comparable reliability information item may be ascertained, this information item, i.e. the quality criterion, may be taken as a basis for selecting an auxiliary data record. By way of example, the quality criterion may contain information about the degree of reliability. The auxiliary data record with the greatest reliability, for example, i.e. the quality criterion that indicates the greatest degree of reliability may be selected.

In this embodiment too, the auxiliary data records may have explicit information items pertaining to ambient conditions for which they are provided. Thus, when an auxiliary data record is selected based on a present temperature, for example, the reliability of the auxiliary data records that are adjacent in terms of temperature may also be ascertained. If the reliability of another auxiliary data record is higher than that of the selected one, the selection may be corrected accordingly.

According to a further embodiment, the generation device is configured to ascertain a quality criterion for each of the auxiliary data records.

The quality criterion may be ascertained, and stored as a supplementary information item, based on bit errors that occur, for example, when a key is produced.

According to a further embodiment, the memory device is configured to store a reference information item for the most recently selected auxiliary data record. In this case, the selection device is configured to select an auxiliary data record based on the reference information item and the supplementary information items.

According to this embodiment, a reference information item may be used for the most recently, e.g., successfully, used auxiliary data record. In the case of an initial key extraction or generation, for testing purposes the auxiliary data records that are adjacent in terms of the ambient conditions, for example the temperature range, may be used.

When a quality criterion is used, it may be determined whether the quality criterion of the adjacent auxiliary data record is better than that of the currently selected one. If this is the case, the adjacent auxiliary data record may be selected and the reference information item therein may be stored as a new reference information item.

This may be useful when it may be assumed that the ambient conditions are not quickly changing considerably. In such cases, the most recently used auxiliary data record still may be used for reliable key generation even in the case of new key generation.

According to a further embodiment, the generation device is configured to perform a challenge/response method using the PUF.

A challenge/response method using the PUF involves a challenge being sent to the PUF. The latter responds to the challenge with a response. The response is then, in turn, used by the generation device to generate the key.

According to a further embodiment, the generation device is a fuzzy key extractor.

A fuzzy key extractor, or fuzzy extractor for short, is a key extractor or key generator that generates a cryptographic key from erroneous input data, such as from biometric data or from data from a physical unclonable function, for example.

According to a further aspect, a method for generating a key using a physical unclonable function, PUF, is described. The method includes the following acts: storage of a plurality of auxiliary data records, where each of the auxiliary data records has auxiliary data and supplementary information items, selection of an auxiliary data record based on the supplementary information items, and generation of the key based on the auxiliary data of the selected auxiliary data record and using the PUF.

In addition, a computer program product is described that prompts the performance of the method as defined above in a program-controlled device. A computer program product, such as a computer-readable memory, may be provided or supplied as a storage medium, such as a memory card, USB stick, CD-ROM, DVD, or else in the form of a downloadable file from a server in a network, for example. This may be accomplished in a wireless communication network, for example, by transmitting an appropriate file with the computer program product or the computer program means.

The embodiments and features described for the described apparatus apply to the described method accordingly.

### BRIEF DESCRIPTION OF THE DRAWINGS

FIG. 1 shows a schematic block diagram of an exemplary embodiment of a key generation apparatus.

FIG. 2 shows a schematic block diagram of another exemplary embodiment of a key generation device.

FIG. 3 shows a schematic flowchart for a method for generating a key in accordance with one embodiment.

In the figures, elements that are the same or that have the same function have been provided with the same reference symbols unless stated otherwise.

### DETAILED DESCRIPTION

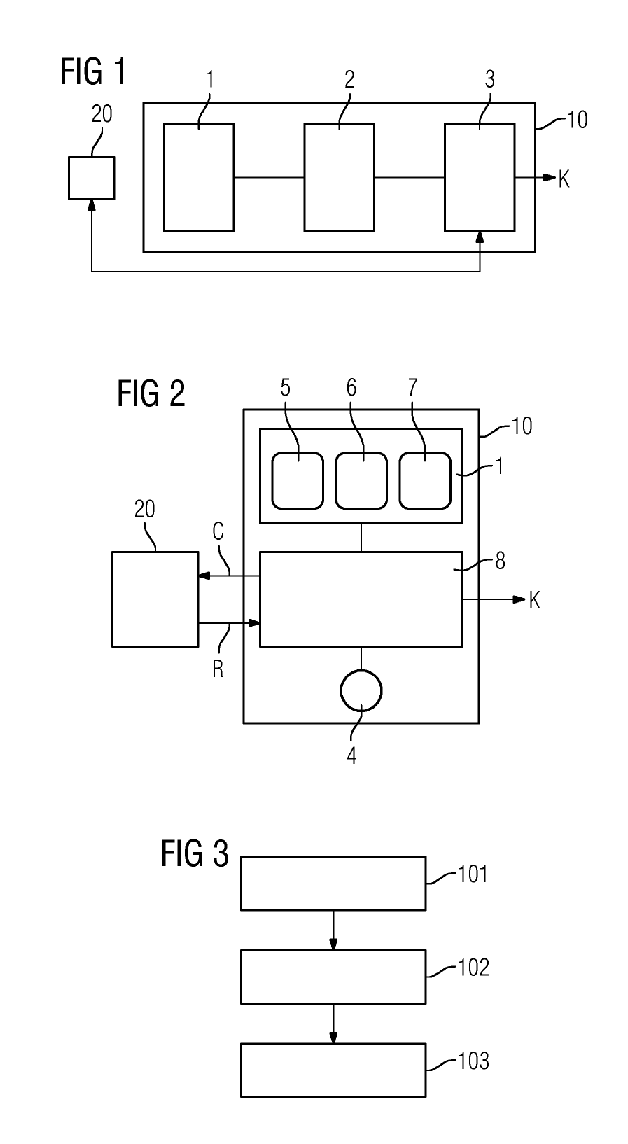

FIG. 1 shows a key generation apparatus 10 for generating a key K using a physical unclonable function (PUF) 20.

A plurality of auxiliary data records 5, 6, 7 (shown in FIG. 2) are stored in a memory device 1. These auxiliary data records 5, 6, 7 have auxiliary data and supplementary information items. The supplementary information items may be values or value ranges for ambient conditions, such as temperatures, for example.

A selection device 2 selects one of the auxiliary data records 5, 6, 7 based on the supplementary information items. Based on the auxiliary data of the selected auxiliary data records 5, 6, 7, a generation device 3 may then generate the key K using the PUF 20.

A further example of a key generation apparatus 10 is shown in FIG. 2.

In this embodiment, an ascertainment device 4 ascertains present ambient conditions for the PUF and forwards a present value to a combined selection and generation apparatus 8. This combined selection and generation apparatus 8 uses this present value to select an auxiliary data record 5, 6, 7 that has the present value in the supplementary information items, and generates the key K. The function of the combined selection and generation apparatus 8 corresponds to a combination of the selection device 2 and the generation device 3 in FIG. 1.

This is described in more detail below using a temperature sensor as ascertainment device 4.

An auxiliary data record 5, 6, 7 then includes the actual auxiliary data or helper data and a temperature range or a temperature value. For the corresponding temperature range, the auxiliary data contained in the same auxiliary data record 5, 6, 7 is used to generate a secure key K that has no or at least few bit errors.

In the event of temperature ranges overlapping, the auxiliary data record 5, 6, 7 with the best fit may be selected, i.e. the one for which the present temperature is best situated in the center. In the event of an auxiliary data record 5, 6, 7 being absent, an error may be output, because no auxiliary data is available for generating a key K. Alternatively, the auxiliary data record 5, 6, 7 with the best fit may be selected, for example the auxiliary data record 5, 6, 7 whose temperature range is least different than the present temperature.

If the key K has been determined, a temperature change to an uncovered range may prompt the creation of a new auxiliary data record 5, 6, 7. It may be ascertained whether an already existent auxiliary data record 5, 6, 7 is sufficiently well suited to determining the key K. It is then not necessary for an additional auxiliary data record 5, 6, 7 to be created, but rather the temperature range of the existent auxiliary data record 5, 6, 7 may be extended, i.e., the supplementary information items may be adapted accordingly.

If an explicit sensor 4 is not in place, a plurality of auxiliary data records 5, 6, 7 may be tried, and a quality criterion for the key extraction may be determined in each case. The quality criteria associated with the auxiliary data records 5, 6, 7 may then be taken as a basis for selecting an auxiliary data record 5, 6, 7.

FIG. 3 shows a flowchart for a method for generating a key K using a PUF 20.

In a first act 101, a plurality of auxiliary data records 5, 6, 7 are stored, each of the auxiliary data records 5, 6, 7 having auxiliary data and supplementary information items. The act 101 may occur during the actual manufacture or may be performed afresh during operation if further auxiliary data records 5, 6, 7 become warranted.

In a second act 102, an auxiliary data record 5, 6, 7 is selected based on the supplementary information items.

Next, in a third act 103, the key K is generated based on the auxiliary data of the selected auxiliary data record 5, 6, 7 and using the PUF 20.

A key generation apparatus and a method for generating a key using a physical unclonable function are described above. The key generation apparatus includes a memory device configured to store a plurality of auxiliary data records, each auxiliary data record of the plurality of auxiliary data records having auxiliary data and supplementary information items, a selection device configured to select an auxiliary data record based on the supplementary information items, and a generation device configured to generate the key based on the auxiliary data of the selected auxiliary data record and using the physical unclonable function.

In order to determine a stable key from a physical unclonable function, error correction is frequently warranted in order to ascertain a stable value from noisy, slightly different physical unclonable function responses. Such error correction may use auxiliary data. In accordance with the key generation apparatus, a plurality of auxiliary data records are available, so that a stable key may reliably be ascertained, e.g., even under changing ambient conditions that influence the physical unclonable function and hence the physical unclonable function responses.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications may be made to the described embodiments. It is therefore intended that the foregoing description be regarded as illustrative rather than limiting, and that it be understood that all equivalents and/or combinations of embodiments are intended to be included in this description.

1. A key generation apparatus for generating a key using a physical unclonable function, the key generation apparatus comprising:
a memory device configured to store a plurality of auxiliary data records, wherein each auxiliary data record of the plurality of auxiliary data records comprises auxiliary data and supplementary information items;
a selection device configured to select an auxiliary data record based on the supplementary information items; and
a generation device configured to generate the key based on the auxiliary data of the selected auxiliary data record and using the physical unclonable function.

2. The key generation apparatus of claim 1, further comprising an ascertainment device configured to ascertain at least one present value for at least one ambient condition of the physical unclonable function, wherein the memory device is configured to store, for each auxiliary data record, at least one reference value for the at least one ambient condition as supplementary information items, and wherein the selection device is configured to select the auxiliary data record based on the at least one present value and the at least one reference value.

3. The key generation device of claim 2, wherein the memory device is configured to store, for each auxiliary data record of the plurality of data records, a reference value range for the at least one ambient condition as a supplementary information item.

4. The key generation device of claim 3, wherein the selection device is configured to select an auxiliary data record of the plurality of auxiliary data records whose reference value range corresponds to the at least one present value.

5. The key generation device of claim 4, wherein, if the stored reference value ranges of the plurality of auxiliary data records overlap, the selection device is configured to select an auxiliary data record of the plurality of auxiliary data records whose reference value range has the at least one present value as a mean value.

6. The key generation device of claim 2, wherein the selection device is configured to output an error signal if none of the supplementary information items has the at least one present value.

7. The key generation device of claim 2, wherein the ascertainment device comprises a sensor configured to capture the at least one present value for at least one ambient condition of the physical unclonable function.

8. The key generation device of claims 2, wherein the at least one ambient condition is an ambient temperature, a humidity, an air pressure, a vibration, an acceleration, a supply voltage, or any combination thereof, for the physical unclonable function.

9. The key generation device of claim 1, wherein the generation device is configured to generate a new auxiliary data record for the plurality of auxiliary data records and to transfer the new auxiliary data record to the memory device for storage.

10. The key generation device of claim 1, wherein the memory device is configured to store, for each auxiliary data record of the plurality of auxiliary data records, a quality criterion as a supplementary information item, and wherein the selection device is configured to select the auxiliary data record based on the quality criterion.

11. The key generation device of claim 10, wherein the generation device is configured to ascertain a quality criterion for each auxiliary data record of the plurality of auxiliary data records.

12. The key generation device of claim 1, wherein the memory device is configured to store a reference information item for a most recently selected auxiliary data record, and wherein the selection device is configured to select an auxiliary data record of the plurality of auxiliary data records based on the reference information item and the supplementary information items.

13. The key generation device of claim 1, wherein the generation device is configured to perform a challenge/response method using the physical unclonable function.

14. The key generation device of claims 1, wherein the generation device is a fuzzy key extractor.

15. A method for generating a key using a physical unclonable function, the method comprising:
storing a plurality of auxiliary data records, wherein each auxiliary data record of the plurality of auxiliary data records comprises auxiliary data and supplementary information items;
selecting an auxiliary data record based on the supplementary information items; and
generating the key based on the auxiliary data of the selected auxiliary data record and with the physical unclonable function.

16. The method of claim 15, further comprising ascertaining at least one present value for at least one ambient condition of the physical unclonable function, wherein storing the plurality of auxiliary data records comprises storing, for each auxiliary data record, at least one reference value for the at least one ambient condition as supplementary information items, and wherein selecting the auxiliary data record comprises selecting the auxiliary data record based on the at least one present value and the at least one reference value.

17. The method of claim 16, wherein storing the plurality of auxiliary data records comprises storing, for each auxiliary data record of the plurality of data records, a reference value range for the at least one ambient condition as a supplementary information item.

18. The method of claim 17, selecting the auxiliary data record comprises selecting an auxiliary data record of the plurality of auxiliary data records whose reference value range corresponds to the at least one present value.

19. The method of claim 18, wherein, if the stored reference value ranges of the plurality of auxiliary data records overlap, selecting the auxiliary data record comprises selecting an auxiliary data record of the plurality of auxiliary data records whose reference value range has the at least one present value as a mean value.

20. The method of claim 16, selecting the auxiliary data record comprises outputting an error signal if none of the supplementary information items has the at least one present value.
